(19) United States
(12) Patent Application Publication
(10) Pub. No.: US 2015/0059658 A1
(43) Pub. Date: Mar. 5, 2015

(54) No Splash Dog Shower

(71) Applicant: Leon Whitsett, Detroit, MI (US)

(72) Inventor: Leon Whitsett, Detroit, MI (US)

(21) Appl. No.: 14/018,416

(22) Filed: Sep. 5, 2013

(51) Int. Cl. A01K 13/00

(52) U.S. Cl. CPC A01K 13/001
USPC 119/671; 119/650

(57) ABSTRACT

A pet washing apparatus for dogs and like animals comprises a cylindrical casing with a top, flat bottom, two end walls, side walls with windows and a pair of hand holes. The casing is provided internally with a plurality of water spray nozzles. The animal stands on a draining floor adapted to be inclined for the discharging of waste water. Air vents are provided in the walls, a vented doubled sided door is provided. The casing connects to a base that raises the casing to an operable height.

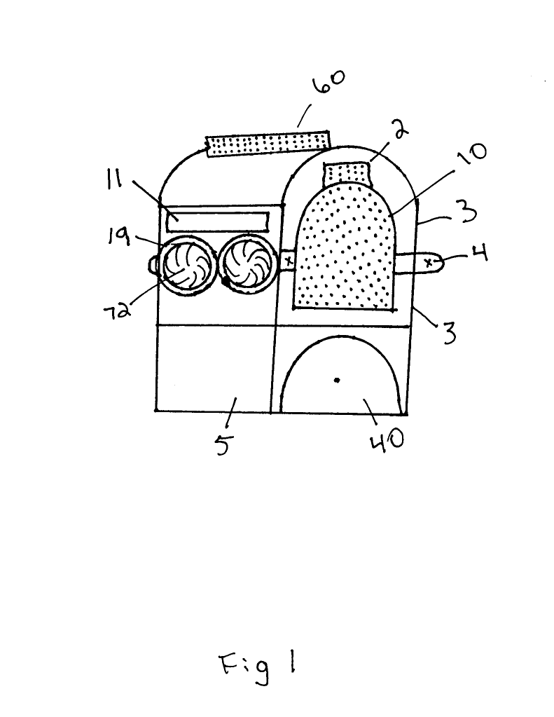

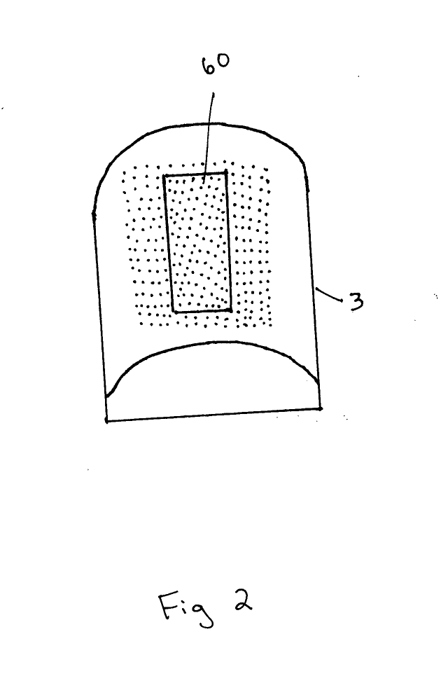

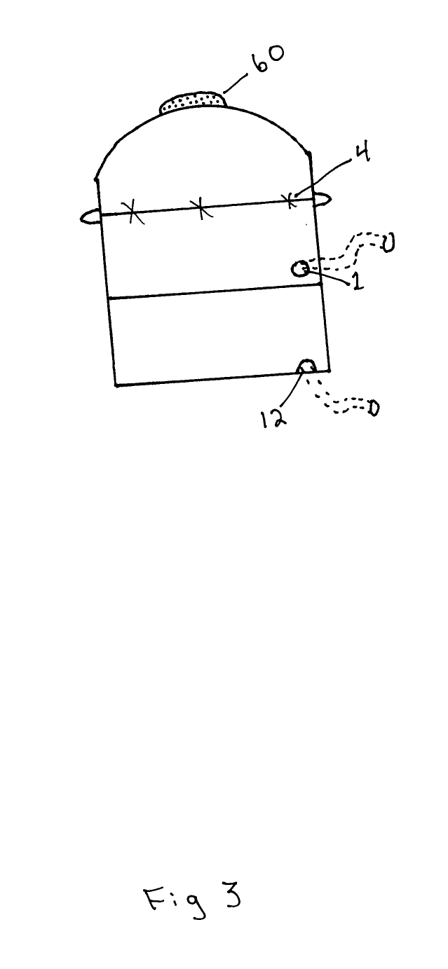

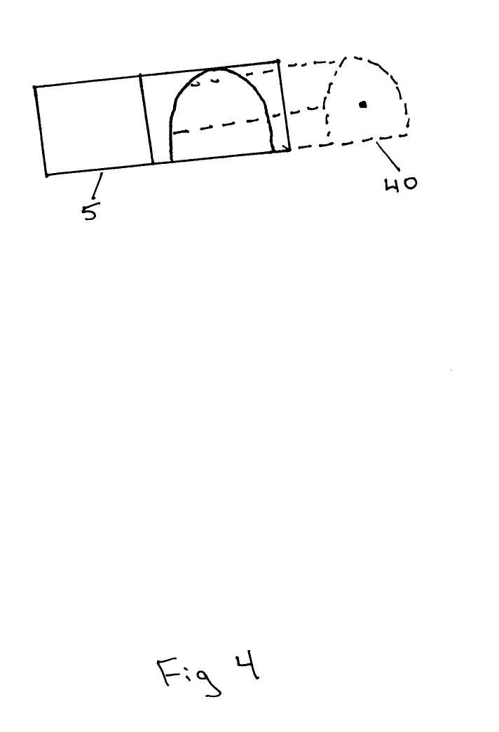

### BACKGROUND OF THE INVENTION

Problem Solved: In the process of washing an animal such as a dog the operator usually has to put the dog in a human's bath tub which is unsanitary to humans, it also leaves the operator with no control of the animal that is being washed which can lead to the operator getting wet.

Other devices are constructed to let the device do the washing and drying mechanically using pressurized soapy water for washing and electricity for drying.

This enclosure is raised at a height that makes it comfortable for the operator to wash and dry the animal.

In the process of washing an animal such as a dog the operator usually has to put the dog in a human's bath tub which is unsanitary to humans, it also leaves the operator with no control of the animal that is being washed which can lead to the operator getting wet. The invention claimed here solves this problem.

A pet washing device for washing a pet without wetting the operator or the area in which the device is positioned.

The claimed invention differs from what currently exists. There are no similar inventions to date, this device completely encloses an animal in its own showering enclosure while allowing the operator to physically wash, dry and observe the animal from the exterior of the device.

These devices don't have proper ventilation, restraint or the ability to observe and have physical contact with the animal from the exterior of the enclosure.

This enclosure has a base that raises the enclosure to a height that makes it comfortable for the operator to wash and dry the animal.

12 at least one outlet hose is affixed to the bottom of the tub and extended from the outlet hole for draining the tub. 72 A pair of spaced hand holes covered a waterproof material could be formed through the side walls. 25 A plurality of inwardly-facing spray nozzles in said casing. 25-1 washing means for supplying clear water to the nozzles under pressure. 35 Drying means for supplying storage space for a pet drying towel inside the accessory caddy. 4 A washing machine wherein first and second portions of the shower enclosure could have respective outer lugs. 3 The housing element could be formed by two separate portions connected respectively to said first and second portions of the annular elements, each portion of said outer housing element having an outer tubular manifold connecting the upper and lower housing portions. 3-5 The washing machine is defined in wherein all parts may be of molded plastic material. 12-50 At least one drain pipe connected to the lower portion of the housing. 12 Spray heads may be connected in the top portion. 55-10 an access door for the entrance and exit of the animal could be in front wall and 12 said slopped floor to drain water therefrom. 2 A door could be hinged in said common front wall manually operable from a location externally of the shower enclosure. At least one common hinged pin passes through the door. 3 A valve located externally on the valve housing could be operable to selectively prevent or allow the flow of water through the valve. 4 A plurality of releasable fasteners could be attached to the exterior rim of the housing for fastening the two portions of the enclosure together. 5 The enclosure is connected to a base that could be of the same material and similar in shape as the upper and lower portions of the enclosure housing. The base raises the enclosure to an operable height and could have a hollowed interspace that allows for an animal stepping stool to be placed in the interior of the stand. 40 a stepping stool could be manually pulled out or pushed into the base from the exterior of the apparatus. 60 air vents are added in the walls of the enclosure for ventilation.
1. Item 35. Accessory caddy shaped to fit enclosures interior.
2. Item 12. The floor of the enclosure is inclined toward the drain for proper drainage. The drain extension can be attached to any suitable hose, such as leading to a conventional drain in the location.
3. Item 55. The entry passage is adapted to facilitate the entrance and exit of a pet into the showering enclosure. The entrance passage is at a height such that an animal may easily step over the wall into the interior of the enclosure.
4. Item 4. A plurality of releasable fasteners are attached to the exterior of the enclosure wherein locking means such as thumb screws.
5. Item 1. The exterior wall portion has an inlet pipe with male threads which are dimensioned to threadlike engage with a female connector of a conventional water source.
6. Item 7. A space in the housing walls provides clearance for members such as pipes and spray heads.
7. Item 50. The enclosure has a sloping bottom; the floor member is disposed in an elevated condition with respect to bottom wall for proper drainage.
8. Item 11. Windows in the side walls are made of a see through material.
9. Item 72. A pair of circular apertures covered with a waterproof material is provided in the walls to receive a pair of human hands.
10. Item 25. The showering enclosure is provided with a plurality of water spray heads which maybe adjustable to permit the direction of the water spray. The spray nozzles are located in the interior of the enclosure between double walls defining an interspace and connected together by pipes that are also enclosed between the inner casings.
11. Item 10. A swinging door mounted in said common wall manually operable from a location externally of the device. The door preferably has double vented walls defining an interspace and at least one common pin passes through said door.
12. Item 60. The enclosure includes air vents in one or more walls thereof.
13. Item 2. The doors hinge is connected in place by means of one or more common hinge pins that passes through the door.
14. Item 19. Sealing stripes made of a suitable waterproof material serve to prevent the water from splashing out of its proper location within the housing.
15. Item 22. The swinging door preferably opens manually from the exterior.
16. Item 5. The enclosures base could be similar in shape and material as the upper and lower portions of the enclosure. The base has a hollowed interspace that allows for an animal stepping stool to be placed in the interior of the base.
17. Item 40. The stepping stool could be of similar shape and material as the base and the upper and lower portions of the enclosure.
18. Item 3. The enclosure could come in two portions (upper-lower) a when both portions come together they form an enclosure.

A pet washing apparatus for dogs and like animals.

I claim:

1. A pet washing device for washing a pet without wetting the area in which the device is positioned.

2. a cylindrical enclosure of plastic material having an outlet hole formed through the bottom thereof.

3. an outlet hose affixed to the bottom of the tub and extending from the outlet hole for draining the tub;

4. A pair of spaced hand holes are formed through the side walls.

5. a plurality of inwardly-facing spray nozzles in said casing;

6. washing means for supplying clear water to the nozzles under pressure;

7. drying means for supplying a pet drying towel inside the accessory caddy.

8. A washing machine wherein said first and second portions of the annular elements have respective outer lugs.

9. the housing element is formed by two separate portions connected respectively to said first and second portions of the annular elements, each portion of said outer housing element having an outer tubular manifold connecting the upper and lower housing portions.

10. The casing interior has said sprayer heads connected to the water supply passage.

11. drying means comprise a pet drying towel inside the accessory caddy.

12. A washing machine is defined in wherein all parts (upper and lower) are of molded plastics material.

13. housing means in which said animal may be confined, said housing means comprising of two sections a top and a bottom, once the two sections are connected the enclosure can be described as having a bottom, a pair of opposed side walls, a pair of opposed end walls and a top;

16. A drain pipe connected to the lower portion of the housing. Spray heads are connected in the top portion. An access door for the entrance and exit of the animal is in front wall and said slopped floor to drain water therefrom.

18. water spray means mounted in said showering enclosure adapted to direct at least one stream of water onto an animal stationed therein;

19. a door hinged in said common front wall manually operable from a location externally of the shower enclosure. A common hinged pin passes through the door.

22. a valve located on the valved housing and being operable to selectively prevent or allow the flow of water through the valve;

23. a plurality of releasable fasteners attached to the exterior rim of the housing for fastening the two sections of the enclosure together.

24. The enclosure sets on a stand that is of the same material and similar in shape of the upper and lower portion of the enclosure housing. The stand and the enclosure mount together by means of metal rods that passes through the bottom lip of the bottom enclosure portion and the top lip of the stand. The stand has a hollowed interspace that allows for an animal stepping stool to be placed in the interior of the stand.

25. The stepping stool can be manually pulled out or pushed into the stand from the exterior of the apparatus when needed.
